(19) United States
(12) Patent Application Publication
(10) Pub. No.: US 2024/0337502 A1
(43) Pub. Date: Oct. 10, 2024

(54) INFORMATION PROCESSING DEVICE, INFORMATION PROCESSING METHOD, AND INFORMATION PROCESSING SYSTEM

(71) Applicant: TOYOTA JIDOSHA KABUSHIKI KAISHA, Toyota-shi (JP)

(72) Inventors: Takafumi KUWAHARA, Okazaki-shi (JP); Daisuke Tanizaki, Kariya-shi (JP); Tetsuro Ishii, Nagoya-shi (JP)

(73) Assignee: TOYOTA JIDOSHA KABUSHIKI KAISHA, Toyota-shi (JP)

(21) Appl. No.: 18/606,538

(22) Filed: Mar. 15, 2024

(30) Foreign Application Priority Data
Apr. 7, 2023 (JP) 2023-062486

(51) Int. Cl. G01C 21/36

(52) U.S. Cl. CPC G01C 21/3697; G01C 21/3682

(57) ABSTRACT

An information processing device includes one or a plurality of processors configured to execute: acquiring a first quotation in response to satisfaction of a first condition, the first quotation being a quotation on a selling price of a resupply object at one or more resupply facilities in a first area that includes a current position of a vehicle; and outputting quotation information that includes the first quotation.

### CROSS-REFERENCE TO RELATED APPLICATION

This application claims priority to Japanese Patent Application No. 2023-062486 filed on Apr. 7, 2023, incorporated herein by reference in its entirety.

### BACKGROUND

### 1. Technical Field

The present disclosure relates to an information processing device, an information processing method, and an information processing system.

### 2. Description of Related Art

There is known a device that acquires information relevant to fuel selling prices at a plurality of refueling facilities and that displays the fuel selling prices and/or price orders at the refueling facilities and the positions of the refueling facilities (see Japanese Unexamined Patent Application Publication No. 2007-293523, for example).

### SUMMARY

The present disclosure provides a technology that makes it possible to improve the convenience for a user when information relevant to resupply facilities in the periphery of a vehicle is presented.

An information processing device according to a first aspect of the present disclosure includes one or a plurality of processors configured to execute: acquiring a first quotation in response to satisfaction of a first condition, the first quotation being a quotation on a selling price of a resupply object at one or more resupply facilities in a first area that includes a current position of a vehicle; and outputting quotation information that includes the first quotation.

An information processing method according to a second aspect of the present disclosure is executed by a computer, and includes: acquiring a first quotation in response to satisfaction of a first condition, the first quotation being a quotation on a selling price of a resupply object at one or more resupply facilities in a first area that includes a current position of a vehicle; and outputting quotation information that includes the first quotation.

An information processing system according to a third aspect of the present disclosure includes: a terminal associated with a vehicle; and a server device configured to communicate with the terminal, wherein: the terminal is configured to send a current position of the vehicle to the server device, in response to satisfaction of a second condition; the server device is configured to acquire a first quotation in response to satisfaction of a third condition, and to send quotation information that includes the acquired first quotation, to the terminal, the first quotation being a quotation on a selling price of a resupply object at one or more resupply facilities in a first area that includes the current position of the vehicle; and the terminal is configured to output the quotation information.

The present disclosure can be regarded as an information processing program for causing the computer to execute the above information processing method, or a non-transitory storage medium that stores the information processing program.

With the present disclosure, it is possible to provide a technology that makes it possible to improve the convenience for a user when information relevant to resupply facilities in the periphery of a vehicle is presented.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the outline of a system in an embodiment;

FIG. 2 is a diagram showing an example of the respective hardware configurations of a terminal and a server device that are included in a system in the embodiment;

FIG. 3 is a block diagram showing an example of the software configuration of the terminal in the embodiment;

FIG. 4 is a block diagram showing an example of the software configuration of the server device in the embodiment;

FIG. 5 is a diagram showing an example of information that is stored in a vehicle information DB in the embodiment;

FIG. 6 is a diagram showing an example of information that is stored in a facility information DB in the embodiment;

FIG. 7 is a sequence diagram for describing processes that are performed by the terminal and the server device in the embodiment;

FIG. 8 is a diagram showing an example of a first screen that is output on the terminal in the embodiment;

FIG. 9 is a flowchart showing an example of a processing routine that is executed by the terminal in the embodiment; and

FIG. 10 is a flowchart showing an example of a processing routine that is executed by the server device in the embodiment.

### DETAILED DESCRIPTION OF EMBODIMENTS

When a user travels in an unfamiliar area by vehicle, there is a possibility that it is difficult to decide a resupply facility where a resupply object such as fuel is resupplied. In response, there is conventionally known a device that displays the respective fuel selling prices at a plurality of resupply facilities in the area and the positions of the resupply facilities. In the device in the related art, the above displaying is performed, for example, even when the vehicle is traveling on an express highway, even when the vehicle is traveling in a familiar area of the user, or even when the traveling-continuable distance of the vehicle is sufficiently long. Therefore, there is a possibility that the user has a feeling of botheration and the convenience is impaired. Consequently, it is desirable to take measures to improve the convenience for the user when resupply facilities in the periphery of the vehicle are presented.

Hence, in an information processing device according to the present disclosure, a control unit acquires a quotation (first quotation) on the selling price of a resupply object at one or more resupply facilities in a first area, in response to the satisfaction of a first condition, and outputs quotation information that includes the acquired first quotation.

As an example, the first condition may include at least one of a condition that the vehicle has entered a general road from an express highway, a condition that the current position of the vehicle is outside the familiar area of the user of the vehicle, a condition that a first time length or more has elapsed from a previous output of the quotation information or the current position of the vehicle is outside a previous first area, and a condition that the traveling-continuable distance of the vehicle is less than a first distance length.

The quotation on the resupply object that is sold at resupply facilities provided on express highways is often uniformly set over the whole of express highways or the country. Further, when the remaining amount of the resupply object becomes small in the case where the vehicle is traveling on an express highway, the user is expected to buy (resupplies the resupply object to the vehicle) the resupply object at a resupply facility provided on the express highway regardless of the quotation on the resupply object. Consequently, when the quotation information is presented in the case where the vehicle is traveling on the express highway, there is a high possibility that the user has a feeling of botheration.

Further, in the case where the current position of the vehicle is inside the familiar area of the user, there is a high possibility that the user knows the quotation on the resupply object that is sold at resupply facilities in the periphery of the vehicle. Consequently, when the quotation information is presented in the case where the current position of the vehicle is inside the familiar area of the user, there is a high possibility that the user has a feeling of botheration.

Further, there is a possibility that the price of the resupply object that is sold at the resupply facility changes every first time length (for example, every 24 hours (1 day)). However, when the elapsed time from the previous output of the quotation information is shorter than the first time length and the current position of the vehicle is inside the previous first area, the quotation information indicating the same price as that in the previous quotation information is output, and there is a high possibility that the user has a feeling of botheration.

Further, in the case where the traveling-continuable distance of the vehicle is sufficiently long, the need to resupply the resupply object is low. Therefore, when the quotation information is output in the case where the traveling-continuable distance of the vehicle is sufficiently long, there is a high possibility that the user has a feeling of botheration.

Consequently, only in the case where the above first condition is satisfied, the quotation information is output, and thereby it is possible to present the quotation information to the user while restraining the user from having a feeling of botheration. As a result, it is possible to improve the convenience for the user when the information relevant to resupply facilities in the periphery of the vehicle is presented.

Examples of the resupply facility include a gas station, a hydrogen station, and a charging station. Examples of the resupply object that is sold at the resupply facility include high-octane gasoline, regular gasoline, light oil, hydrogen, and electricity.

Further, for example, the control unit of the information processing device according to the present disclosure acquiring the first quotation may include: acquiring the selling price of the resupply object at each of the one or more resupply facilities in the first area; and computing the first quotation based on the selling price of the resupply object at each of the one or more resupply facilities. In that case, as an example, the first quotation may be the average of the respective selling prices of the resupply object at the one or more resupply facilities. As another example, the first quotation may be the median of the respective selling prices of the resupply object at the one or more resupply facilities.

Further, for example, the control unit of the information processing device according to the present disclosure outputting the quotation information may include: outputting the first quotation; and outputting the position of each of the one or more resupply facilities in the first area and the selling price of the resupply object at each of the one or more resupply facilities. Thereby, the user can know the position of each of the one or more resupply facilities in the first area and the selling price of the resupply object at each of the one or more resupply facilities, and can determine whether the selling price of the resupply object at each resupply facility is high or low compared to the first quotation.

When the selling price of a kind of resupply object that is not adapted to the vehicle and the first quotation on the selling price are output, there is a high possibility that the user has a feeling of botheration. Consequently, the output of the selling price and the first quotation may be executed only about a kind of resupply object that is adapted to the vehicle. For example, in the case where the kind of the resupply object that is adapted to the vehicle is high-octane gasoline, only the selling price and the first quotation about the high-30 octane gasoline may be output. Thereby, it is possible to further restrain the user from having a feeling of botheration.

Further, the control unit of the information processing device according to the present disclosure outputting the quotation information may further include outputting a first date that is a date when the selling price of the resupply object at each of the one or more resupply facilities in the first area is posted. Thereby, the user can know the time point when the information about the presented selling price and first quotation was released.

The information processing device according to the present disclosure may be a terminal that is equipped in the vehicle or a terminal that is carried by the user of the vehicle. In that case, the control unit of the information processing device may be a processor of the terminal. In the case where the information processing device is such a terminal, the control unit may acquire the quotation information through an external device (for example, a server device, a database, or the like). Further, as an example, the control unit may output the quotation information through a car navigation program of the terminal. On that occasion, the control unit may output the position of each of the one or more resupply facilities in the first area and the selling price of the resupply object at each of the one or more resupply facilities, on a map screen for the car navigation program. Furthermore, the control unit may output the first quotation as voice, and/or may output character information expressing the first quotation, in the margin of the above map screen.

Further, the information processing device according to the present disclosure may be a server device. In that case, the control unit of the information processing device may acquire the current position of the vehicle through the terminal that is equipped in the vehicle or the terminal that is carried by the user of the vehicle. Further, the control unit of the information processing device may output the quotation information through the terminal that is equipped in the vehicle or the terminal that is carried by the user of the vehicle.

Further, the present disclosure can be regarded as an information processing system that includes a terminal and a server device. In that case, the terminal may be configured to execute sending the current position of the vehicle to the server device, in response to satisfaction of a second condition, and outputting the quotation information that is sent from the server device. Further, the server device may be configured to execute acquiring the first quotation in response to satisfaction of a third condition, and sending quotation information that includes the acquired first quotation, to the terminal. The second condition may include a part of the above first condition. As an example, the second condition may include a condition that the vehicle has entered a general road from an express highway and/or a condition that the traveling-continuable distance of the vehicle is less than a first distance length. Further, the third condition may include the remaining part of the above first condition. As an example, the third condition may include a condition that the current position of the vehicle is outside the familiar area of the user of the vehicle and/or a condition that the first time length or more has elapsed from the previous output of the quotation information or the current position of the vehicle is outside the previous first area.

With the above information processing system, it is possible to obtain the same function effect as that of the above information processing device.

A specific embodiment of the present disclosure will be described below based on the drawings. A hardware configuration, a module configuration, a functional configuration, and others described in the following embodiment are not intended to limit the technical scope of the present disclosure only to them, unless otherwise described.

### EMBODIMENT

In the embodiment, an example in which an information processing device according to the present disclosure is applied to a system for providing information about a vehicle having an electricity supply function will be described.

### Outline of System

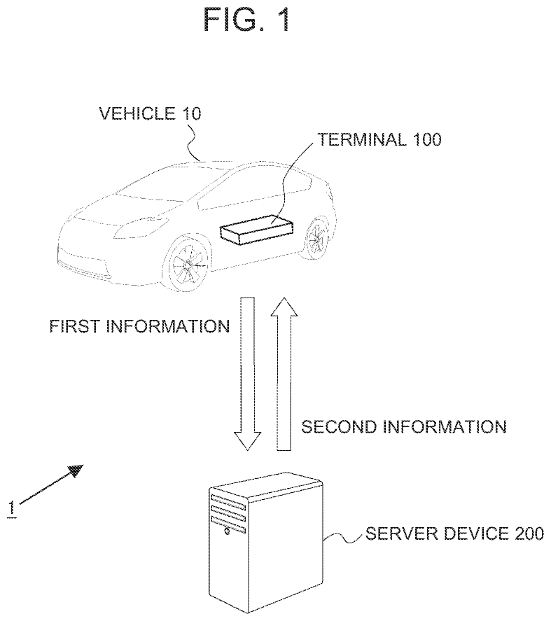

FIG. 1 is a diagram showing the outline of a system in the embodiment. The system in the embodiment is configured to include a terminal 100 and a server device 200. The terminal 100 and the server device 200 are connected through a later-described network N1. In the example shown in FIG. 1, only one terminal 100 is illustrated, but a plurality of terminals 100 (vehicles 10) can be included under the management of the server device 200.

The terminal 100 is associated with the vehicle 10. The vehicle 10 is a vehicle (an internal combustion engine vehicle (ICEV), a hybrid electric vehicle (HEV), a plug-in hybrid electric vehicle (PHEV), or the like) in which the resupply object is fuel (high-octane gasoline or regular gasoline), a vehicle (a fuel cell electric vehicle (FCEV), or the like) in which the resupply object is hydrogen, or a vehicle (a battery electric vehicle (BEV), a plug-in hybrid electric vehicle (PHEV), or the like) in which the resupply object of electricity.

For example, the terminal 100 is a terminal that is equipped in the vehicle 10, a portable terminal that is used by a user of the vehicle 10, or the like. The terminal 100 is configured to send first information to the server device 200, when a later-described start-up condition is satisfied. As an example, the first information includes the current position and identifier (vehicle ID) of the vehicle. Further, the terminal 100 is configured to output quotation information included in second information that is sent from the server device 200, when the terminal 100 receives the second information. As an example, the quotation information includes the quotation (first quotation) on the selling price of the resupply object in a peripheral area (first area) of the vehicle 10.

The resupply object that is the object of the above first quotation is a kind of resupply object that is adapted to the vehicle 10. For example, in the case where the resupply object that is adapted to the vehicle 10 is high-octane gasoline, the object of the first quotation is high-octane gasoline. Further, in the case where the resupply object that is adapted to the vehicle 10 is regular gasoline, the object of the first quotation is regular gasoline. Further, in the case where the resupply object that is adapted to the vehicle 10 is light oil, the object of the first quotation is light oil. Further, in the case where the resupply object that is adapted to the vehicle 10 is hydrogen, the object of the first quotation is hydrogen. Further, in the case where the resupply object that is adapted to the vehicle 10 is electricity, the object of the first quotation is electricity.

The server device 200 is configured to determine whether a later-described notification condition is satisfied, when the server device 200 receive the first information that is sent from the terminal 100. The server device 200 is configured to specify one or more resupply facilities in the first area that includes the current position of the vehicle 10, and compute the first quotation based on the selling price of the resupply object at each of the one or more specified resupply facilities, in the case where it is determined that the notification condition is satisfied. The server device 200 is configured to generate the quotation information that includes the computed first quotation. Furthermore, the server device 200 is configured to send the second information that includes the generated quotation information, to the terminal 100.

In a system 1 in the embodiment, the quotation information is output to the terminal 100, only in the case where the second condition and the third condition are satisfied. As a result, it is possible to present the quotation information to the user while restraining the user from having a feeling of botheration.

### Hardware Configuration

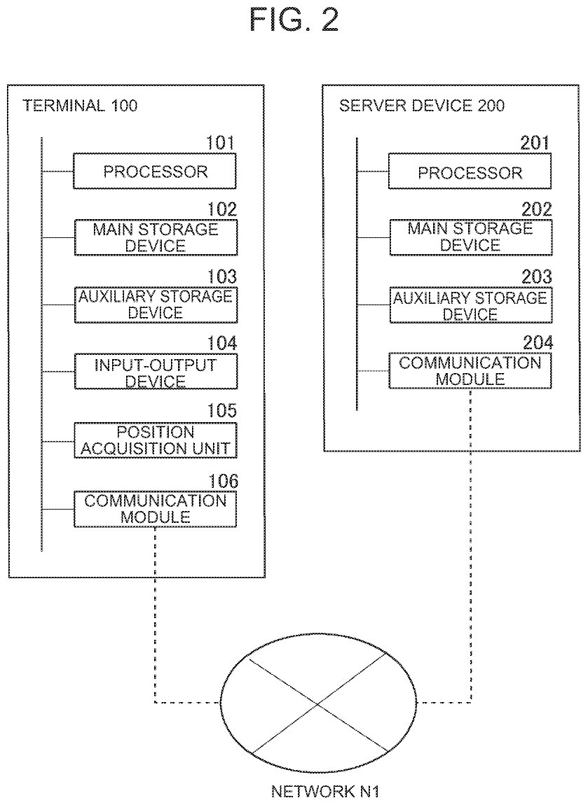

FIG. 2 is a diagram showing an example of the respective hardware configurations of the terminal 100 and the server device 200 that are included in the system 1 in the embodiment. The terminal 100 in the embodiment is a computer (for example, a computer that provides a car navigation service, or the like) that is equipped in the vehicle 10, or a portable computer (for example, a smartphone, a tablet terminal, or the like) that is used by the user of the vehicle 10. The server device 200 in the embodiment is a computer that is connected with the terminal 100 through the network N1.

As shown in FIG. 2, the terminal 100 is configured to include a processor 101, a main storage device 102, an auxiliary storage device 103, an input-output device 104, a position acquisition unit 105, and a communication module 106. In the example shown in FIG. 2, only the hardware configuration relevant to the service for providing the quotation information is extracted and illustrated, but the terminal 100 can include another hardware configuration.

The processor 101 is arithmetic processing unit such as a central processing unit (CPU), a graphics processing unit (GPU), or a digital signal processor (DSP). The processor 101 loads and executes programs stored in the auxiliary storage device 103, on the main storage device 102, and thereby realizes later-described functions (software modules) that match with predetermined purposes.

For example, the main storage device 102 is configured to include a semiconductor memory such as a random-access memory (RAM) and a read-only memory (ROM). The main storage device 102 provides a storage region for loading programs stored in the auxiliary storage device 103, and a working region. Further, the main storage device 102 is used as a buffer for the arithmetic processing by the processor 101.

For example, the auxiliary storage device 103 is an erasable programmable ROM (EPROM) or a hard disk drive (HDD). The auxiliary storage device 103 can include a removable medium, that is, a portable recording medium. For example, the removable medium is a disc recording medium such as a universal serial bus (USB) memory, a compact disc (CD), or a digital versatile disc (DVD). The auxiliary storage device 103 stores various programs, data that is used by the processor 101 for the execution of programs, and the like.

The programs stored in the auxiliary storage device 103 include dedicated programs for causing the processor 101 to execute processes relevant to the service for providing the quotation information, and the like, in addition to an operating system (OS).

The input-output device 104 accepts the input operation that is performed by the user of the vehicle 10, and presents information to the user. Specifically, for example, the input-output device 104 includes an input apparatus such as a touch panel or a push button through which symbols such as characters can be input and a microphone through which voice can be input. Further, the input-output device 104 includes an output apparatus such as a display or a speaker. For the input-output device 104, the input apparatus and the output apparatus may be integrally configured as a touch panel display or the like. In that case, the touch panel display may be a touch panel display of a car navigation system.

The position acquisition unit 105 acquires the current position (geographical coordinates such as latitude and longitude) of the vehicle 10. As an example, the position acquisition unit 105 may be a global positioning system (GPS) receiver. As another example, the position acquisition unit 105 may be a wireless communication circuit that uses a position information service through Wi-Fi (R).

The communication module 106 is a communication interface for connecting the terminal 100 to the network N1. As an example, the communication module 106 is configured to include a network interface that is connected to the network N1 using a mobile communication system (for example, long term evolution (LTE), LTE-Advanced, 5th generation (5G), 6th generation (6G), or the like), or using a wireless communication system such as Wi-Fi (R). The communication module 106 communicates with the server device 200 and the like through the network N1. For example, the network N1 is a wide area network (WAN) that is a worldwide public telecommunication network, as exemplified by the internet, or another communication network.

For the hardware configuration of the terminal 100, depending on the embodiment, the omission, replacement and addition of constituent elements can be performed when appropriate. For example, the terminal 100 may include a plurality of processors. Further, the terminal 100 may be configured to include a plurality of computers (for example, a computer for communication, a computer for the car navigation system, and the like).

Next, as shown in FIG. 2, the server device 200 is configured to include a processor 201, a main storage device 202, an auxiliary storage device 203, and a communication module 204. In the example shown in FIG. 2, only the hardware configuration relevant to the service for providing the quotation information is extracted and illustrated, but the server device 200 can include another hardware configuration.

The processor 201, the main storage device 202, and the auxiliary storage device 203 of the server device 200 are the same as the processor 101, the main storage device 102, and the auxiliary storage device 103 of the terminal 100, respectively, and therefore the description thereof is omitted.

The communication module 204 of the server device 200 is a communication interface for connecting the server device 200 to the network N1. As an example, the communication module 204 may be configured to include a network interface board, a wireless communication interface for wireless communication, and the like. The communication module 204 communicates with the terminal 100 and the like through the network N1.

### Functional Configuration of Terminal

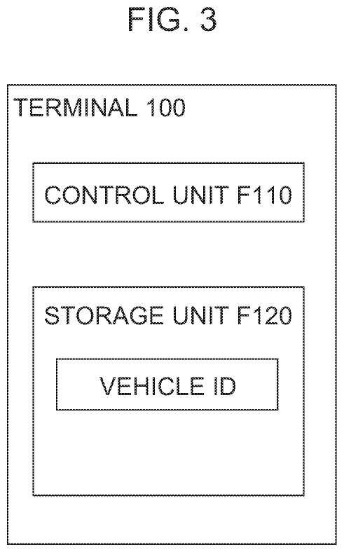

The functional configuration (software configuration) of the terminal 100 in the embodiment will be described based on FIG. 3. FIG. 3 is a block diagram showing the software configuration of the terminal 100. The terminal 100 in the embodiment is configured to include two software modules: a control unit F110 and a storage unit F120.

The control unit F110 may be realized by the execution of programs stored in the auxiliary storage device 103 by the processor 101. Further, the control unit F110 may be realized by a hardware circuit such as an application specific integrated circuit (ASIC) or a field programmable gate array (FPGA).

The control unit F110 in the embodiment determines whether the start-up condition is satisfied. The start-up condition in the embodiment includes a condition (1) that the vehicle 10 has entered a general road from an express highway and a condition (2) that the traveling-continuable distance of the vehicle 10 is less than a first distance length. The combination of the condition (1) and the condition (2) corresponds to the “second condition” according to the present disclosure.

For example, whether the condition (1) is satisfied may be determined based on the history of the traveling route of the vehicle 10 that is acquired by the car navigation system and the current position of the vehicle 10 that is acquired by the position acquisition unit 105, or may be determined based on information about the settlement with an electronic toll collection system (ETC) in-vehicle machine. This information processing may be repeatedly executed with a predetermined period, during the traveling of the vehicle 10. As another method, this information processing may be repeatedly executed with a predetermined period, during the traveling of the vehicle 10 on express highways.

In the case where it is determined that the condition (1) is satisfied, the control unit F110 determines whether the condition (2) is satisfied. For this determination, the control unit F110 computes the traveling-continuable distance of the vehicle 10. As an example, the traveling-continuable distance may be computed using the remaining amount (for example, remaining fuel amount, remaining hydrogen amount, remaining battery level, or the like) of the resupply object in the vehicle 10 and the average fuel economy or average electricity economy of the vehicle 10. Further, the first distance length is arbitrarily set depending on the embodiment. As an example, the first distance length may be a distance resulting from adding a margin to the distance from the current position of the vehicle 10 to the outside of the first area. For example, in the case where the first area is set to a range of a several kilometers radius around the current position of the vehicle 10, the first distance length may be set to a distance length resulting from adding a margin to the radius. As an example, the first distance length may be a distance length resulting from adding a margin to the distance length from the current position of the vehicle 10, to the destination set in the car navigation system.

In the case where it is determined that the condition (2) is satisfied, the control unit F110 acquires the current position of the vehicle 10 through the position acquisition unit 105. The control unit F110 reads the vehicle ID stored in the later-described storage unit F120. The control unit F110 sends the first information including the current position of the vehicle 10 and the vehicle ID to the server device 200 through the communication module 106.

When the communication module 106 receives the second information that is sent from the server device 200 in response to the above first information, the control unit F110 determines whether the second information includes the quotation information. In the case where the second information includes the quotation information, the control unit F110 outputs the quotation information through the input-output device 104. Details of the output of the quotation information will be described later. In the case where the second information does not include the quotation information, the control unit F110 does not output any information from the input-output device 104.

Further, the storage unit F120 of the terminal 100 is a logical storage region that is constructed in the auxiliary storage device 103. In the storage unit F120 in the embodiment, the vehicle ID of the vehicle 10 is stored. The vehicle ID is information for identifying the vehicle 10. As an example, the vehicle ID may be the vehicle identification number of the vehicle 10. As another example, the vehicle ID may be a character string that is written on the vehicle registration plate of the vehicle 10. The vehicle ID may be a character string that is arbitrarily given by the server device 200.

The software configuration of the terminal 100 is not limited to the example shown in FIG. 3, and the omission, replacement, and addition of software constituent elements can be performed when appropriate.

### Functional Configuration of Server

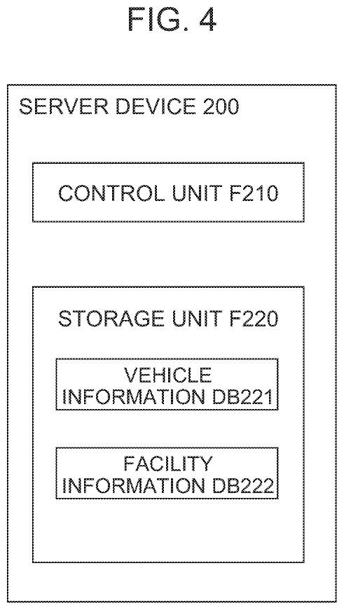

The functional configuration (software configuration) of the server device 200 in the embodiment will be described based on FIG. 4. FIG. 4 is a block diagram showing an example of the software configuration of the server device 200. The server device 200 in the embodiment is configured to include two software modules: a control unit F210 and a storage unit F220.

The control unit F210 may be realized by the execution of programs stored in the auxiliary storage device 203 by the processor 201. Further, the control unit F210 may be realized by a hardware circuit such as an ASIC or an FPGA.

The control unit F210 in the embodiment determines whether the notification condition is satisfied, when the first information sent from the terminal 100 is received. The notification condition in the embodiment includes a condition (3) that the current position of the vehicle 10 is outside the familiar area of the user and a condition (4) that the current position of the vehicle 10 is outside the previous first area or a first time length or more has elapsed from the previous notification. The combination of the condition (3) and the condition (4) corresponds to the “third condition” according to the present disclosure.

For example, whether the condition (3) is satisfied is determined based on the current position of the vehicle 10 that is included in the first information and information that is stored in a later-described vehicle information DB 221. Further, for example, whether the condition (4) is satisfied is determined based on the current date and time and information that is stored in the later-described vehicle information DB 221.

In the case where it is determined that the condition (3) and the condition (4) are satisfied, the control unit F210 sets the first area based on the current position of the vehicle 10 that is included in the first information. As an example, the first area is set to a range of a several kilometers radius around the current position of the vehicle 10. The setting method for the first area is not limited to the above method, and the first area can be arbitrarily set within a range including the current position of the vehicle 10. Further, the first area may be set so as to be defined by geographic coordinates.

After the control unit F210 sets the first area, the control unit F210 specifies one or more resupply facilities in the first area, based on the geographic coordinates of the first area and information stored in a facility information DB 222. On that occasion, resupply facilities provided on express highways and resupply facilities where a kind of resupply object (also referred to as a “first kind of resupply object” hereinafter) that is adapted to the vehicle 10 is not sold are excluded. In other words, one or more resupply facilities that are positioned along general roads and where the first kind of resupply object is sold are specified among resupply facilities in the first area.

The control unit F210 computes the quotation (first quotation) on the resupply object in the first area, based on the selling price of the first kind of resupply object at each of the one or more specified resupply facilities. As an example, the control unit F210 may compute the average or median of the selling prices of the first kind of resupply object at one or more resupply facilities, and may adopt the computed average or median as the first quotation.

After the control unit F210 computes the first quotation, the control unit F210 generates the quotation information. As an example, the quotation information may include the first quotation, the position of each of the above one or more specified resupply facilities, and the selling price of the first kind of resupply object at each of the above one or more specified resupply facilities. The quotation information may further include the name of each of the above one or more specified resupply facilities.

The control unit F210 sends the second information that includes the generated quotation information, to the terminal 100 through the communication module 204. In the case where it is determined that at least one of the condition (3) and the condition (4) is not satisfied, the control unit F210 sends the second information that does not include the quotation information, to the terminal 100 through the communication module 204.

Next, the storage unit F220 of the server device 200 is a logical storage region that is constructed in the auxiliary storage device 203. In the storage unit F220 in the embodiment, the vehicle information DB 221 and the facility information DB 222 are constructed. The vehicle information DB 221 and the facility information DB 222 are constructed by the execution of programs for a data management system (DBMS) by the processor 201 of the server device 200. On that occasion, the vehicle information DB 221 and the facility information DB 222 may be constructed as relational databases.

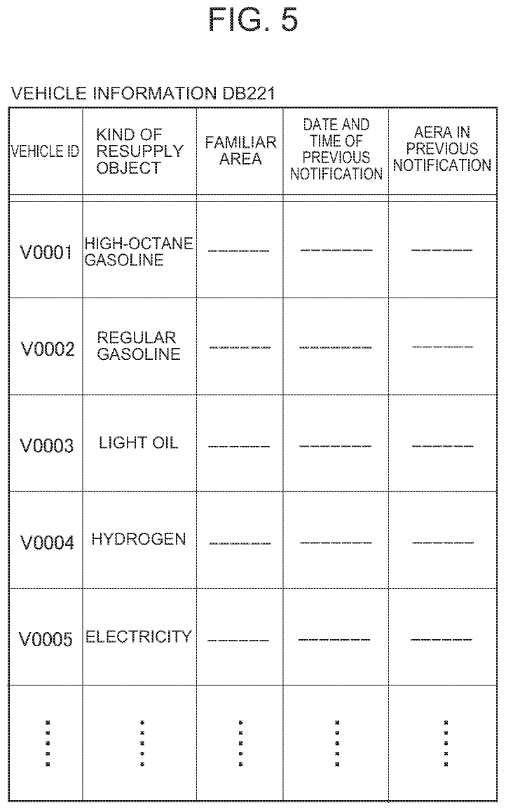

FIG. 5 is a diagram showing an example of the information that is stored in the vehicle information DB 221 in the embodiment. As exemplified in FIG. 5, the vehicle information DB 221 in the embodiment has a plurality of records (also referred to as “vehicle information records” hereinafter) that respectively corresponds to a plurality of vehicles 10 under the management of the server device 200. As shown in FIG. 5, each vehicle information record has fields for the vehicle ID, the kind of the resupply object, the familiar area, the date and time of the previous notification, and the area in the previous notification. The configuration of the vehicle information record is not limited to the example shown in FIG. 5, and the omission, replacement, and addition of fields can be performed when appropriate.

In the field for the vehicle ID, information (vehicle ID) for identifying each of the plurality of vehicles 10 under the management of the server device 200 is registered. As described above, the information that is registered in the field for the vehicle ID may be the vehicle identification number of the vehicle 10, the character string that is written on the vehicle registration plate, or the like.

In the field for the kind of the resupply object, the kind (first kind) of the resupply object that is adapted to the vehicle 10 is registered. For example, for the vehicle 10 in which the first kind of resupply object is high-octane gasoline, “high-octane gasoline” is registered in the field for the kind of the resupply object. For the vehicle 10 in which the first kind of resupply object is regular gasoline, “regular gasoline” is registered in the field for the kind of the resupply object. For the vehicle 10 in which the first kind of resupply object is light oil, “light oil” is registered in the field for the kind of the resupply object. For the vehicle 10 in which the first kind of resupply object is hydrogen, “hydrogen” is registered in the field for the kind of the resupply object. For the vehicle 10 in which the first kind of resupply object is electricity, “electricity” is registered in the field for the kind of the resupply object.

In the field for the familiar area, the range of the familiar area of the user of the vehicle 10 is registered. As an example, geographic coordinates of an area of several kilometers to several tens of kilometers radius around the home of the user of the vehicle 10, or geographic coordinates of an area of a several kilometers to several tens of kilometers radius around the workplace of the user of the vehicle 10 may be registered in the field for the familiar area.

In the field for the date and time of the previous notification, the date and time when the second information including the quotation information was sent to the terminal 100 corresponding to the vehicle 10 on the previous time is registered. That is, the date and time of the previous sending of the second information including the quotation information is registered in the field for the date and time of the previous notification.

In the field for the area in the previous notification, information indicating the first area when the second information including the quotation information was sent to the terminal 100 corresponding to the vehicle 10 on the previous time is registered. That is, information indicating the first area at the time of the previous sending of the second information including the quotation information is registered in the field for the area in the previous notification.

The information that is registered in the field for the date and time of the previous notification and the information that is registered in the field for the area in the previous notification are updated whenever the second information including the quotation information is sent to the terminal 100 corresponding to the vehicle 10.

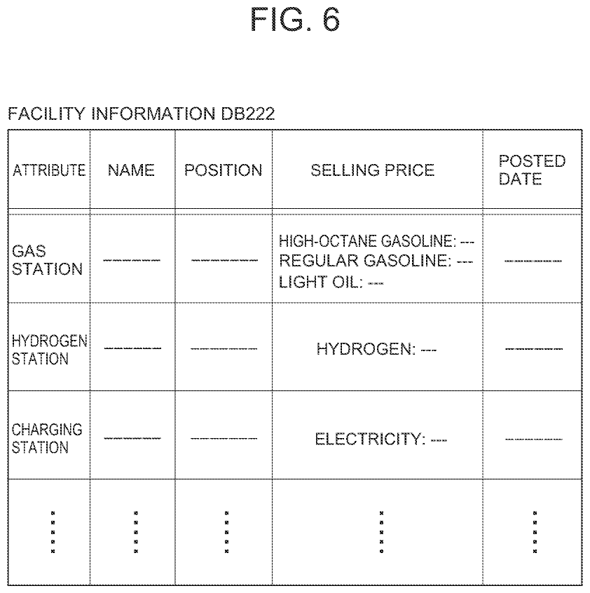

Next, the information that is stored in the facility information DB 222 in the embodiment will be described based on FIG. 6. FIG. 6 is a diagram showing an example of the information that is stored in the facility information DB 222 in the embodiment. As shown in FIG. 6, the facility information DB 222 in the embodiment has a plurality of records (also referred to as “facility information records” hereinafter) that respectively corresponds to a plurality of resupply facilities. In the embodiment, resupply facilities provided on express highways are excluded from the object that is registered in the facility information DB 222. That is, the object that is registered in the facility information DB 222 includes only resupply facilities that are positioned along general roads.

As shown in FIG. 6, each facility information record of the facility information DB 222 has fields for attribute, name, position, selling price, posted date, and the like. The configuration of the facility information record is not limited to the example shown in FIG. 6, and the omission, replacement, and addition of fields can be performed when appropriate.

In the field for the attribute, the attribute of the resupply facility is registered. This “attribute” is defined based on the kind of the resupply object that is sold at the facility. For example, for the resupply facility where fuel such as high-octane gasoline, regular gasoline, and light oil are sold, “gas station” is registered in the field for the attribute. For the resupply facility where hydrogen is sold, “hydrogen station” is registered in the field for the attribute. For the resupply facility where electricity is sold, “charging station” is registered in the field for the attribute.

In the field for the name, the proper name of the resupply facility is registered. In the field for the position, geographic coordinates indicating the position of the resupply facility is registered. In the field for the selling price, the price of the resupply object that is sold at the resupply facility is registered. For the resupply facility that is a gas station, the price of high-octane gasoline, the price of regular gasoline, and the price of light oil are registered in the field for the selling price. For the resupply facility that is a hydrogen station, the price of hydrogen is registered in the field for the selling price. For the resupply facility that is a charging station, the price of electricity is registered in the field for the selling price. In the field for the posted date, the date when the selling price registered in the selling price field for the resupply facility was posted is registered.

The information that is registered in the field for the selling price and the information that is registered in the field for the posted date are updated whenever the selling price that is posted by the resupply facility is altered.

The software configuration of the server device 200 is not limited to the example shown in FIG. 4, and the omission, replacement, and addition of software constituent elements can be performed when appropriate. For example, the vehicle information DB 221 and/or the facility information DB 222 may be constructed in an external device that is connected with the server device 200 through the network N1. In that case, the control unit F210 of the server device 200 may acquire the information that is stored in the vehicle information DB 221 and/or the facility information DB 222, by accessing the external device as necessary.

### Flow of Processes

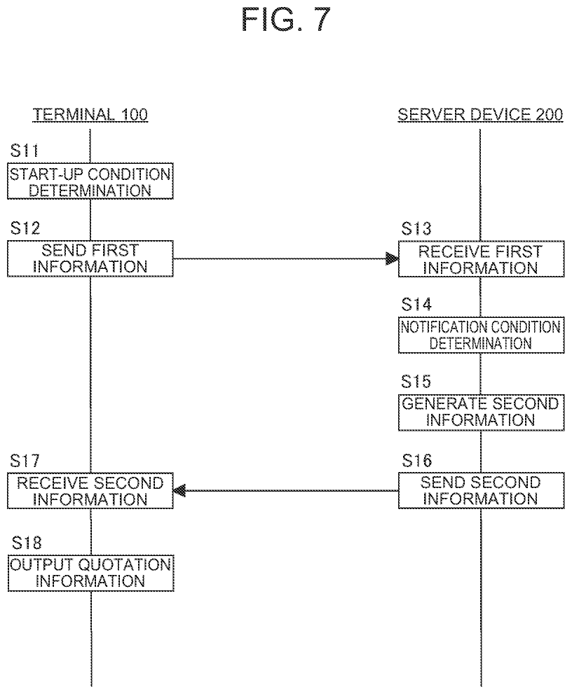

Next, processes that are performed by the terminal 100 and the server device 200 of the system 1 in the embodiment will be described based on FIG. 7. FIG. 7 is a diagram showing a sequence for the processes that are performed by the terminal 100 and the server device 200 in the embodiment.

In the example shown in FIG. 7, first, in step S11, the control unit F110 of the terminal 100 determines whether the start-up condition is satisfied. As an example, the control unit F110 determines (1) whether the vehicle 10 has entered the general road from the express highway and (2) whether the traveling-continuable distance of the vehicle 10 is less than the first distance length. In the case where it is determined that the condition (1) and the condition (2) are satisfied, the control unit F110 executes the process of step S12.

In step S12, the control unit F110 of the terminal 100 sends the first information to the server device 200 through the communication module 106. As described above, the first information includes the current position of the vehicle 10 that is acquired by the position acquisition unit 105 and the vehicle ID that is stored in the storage unit F120.

In step S13, the first information sent from the terminal 100 is received by the communication module 204 of the server device 200.

In step S14, the control unit F210 of the server device 200 determines whether the notification condition is satisfied. As an example, the control unit F210 determines (3) whether the current position of the vehicle 10 is outside the familiar area of the user and (4) whether the current position of the vehicle 10 is outside the previous first area or the first time length or more has elapsed from the previous notification. In the case where it is determined that the condition (3) and the condition (4) are satisfied, the control unit F210 executes the process of step S15.

In step S15, the control unit F210 of the server device 200 generates the second information. Specifically, the control unit F210 generates the quotation information based on the current position of the vehicle 10 that is included in the first information and the information that is stored in the facility information DB 222, and generates the second information that includes the generated quotation information. As an example, the quotation information includes the first quotation, the position of each of one or more resupply facilities where the first kind of resupply object is sold in the first area, the name of each of the one or more resupply facilities, the selling price of the first kind of resupply object at each of the one or more resupply facilities, and the like. On that occasion, the first quotation is evaluated by computing the average or median of the selling prices of the first kind of resupply object at the above one or more resupply facilities.

In step S16, the control unit F201 of the server device 200 sends the second information to the terminal 100 through the communication module 204.

In step S17, the second information sent from the server device 200 is received by the communication module 106 of the terminal 100.

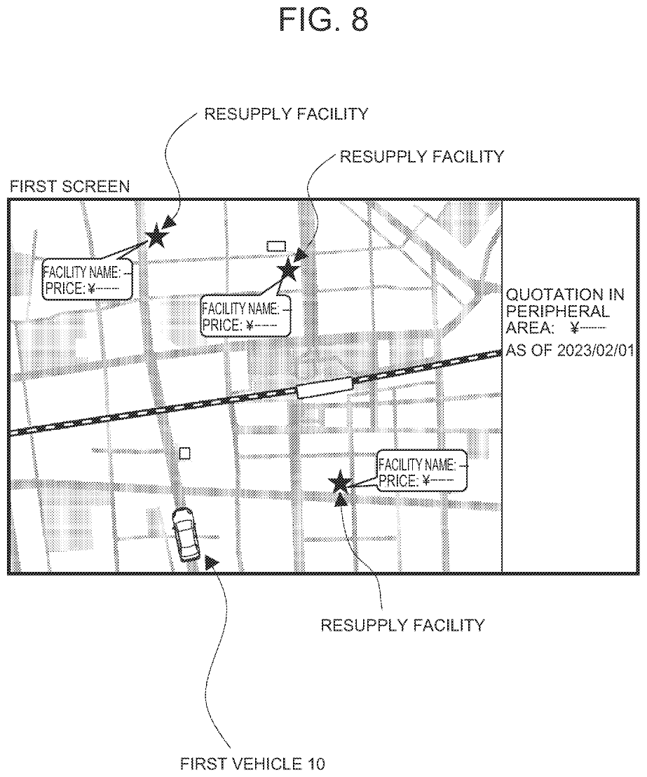

In step S18, the control unit F110 of the terminal 100 outputs the quotation information included in the second information. As an example, the control unit F110 of the terminal 100 outputs a first screen exemplified in FIG. 8 to the input-output device 104 through the car navigation system. In the example shown in FIG. 8, the first screen includes GUI components that are superimposed on the respective positions of the above one or more resupply facilities on the map of the car navigation system and each of which includes an icon, a name, and the selling price of the first kind of resupply object, and a GUI component that includes character information about the first quotation and a first date. On that occasion, for the first quotation and the first date, the output of voice may be also executed. The first date is a date when the selling price used for the computation of the first quotation was posted. In the case where dates when one or more selling prices used for the computation of the first quotation were posted are different from each other, the earliest posted date may be set as the first date.

### Processing Flow

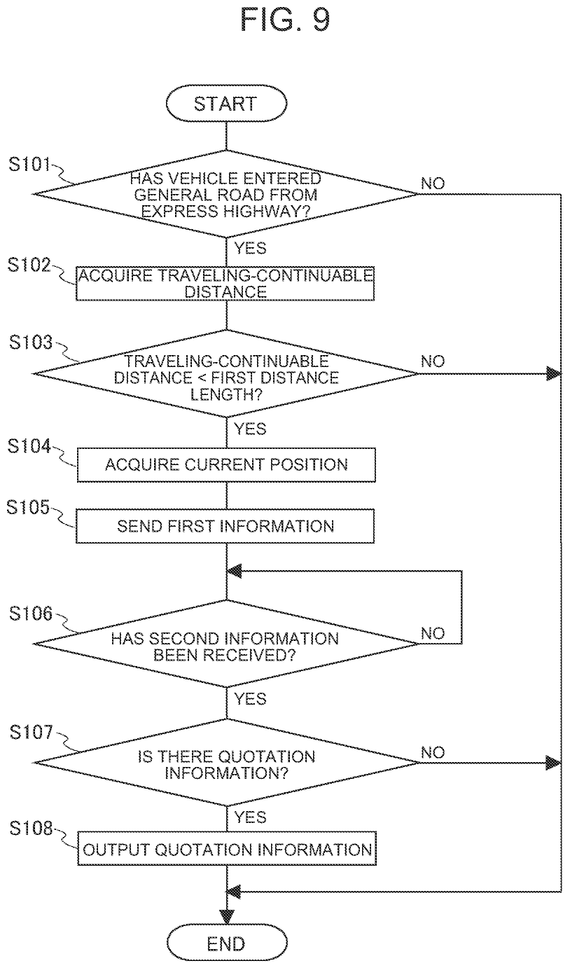

An information process that is performed by the terminal 100 in the embodiment will be described based on FIG. 9. FIG. 9 is a flowchart showing a processing flow (a specific processing procedure for the above steps S11 to S12 and the above steps S17 to S18) that is performed by the terminal 100. The processing flow shown in FIG. 9 is repeatedly executed with a predetermined period, during the traveling of the vehicle 10 or during the traveling on the express highway.

The execution subject of the processing flow in FIG. 9 is the processor 101 of the terminal 100, but the description will be made assuming that the software modules of the terminal 100 are adopted as the execution subject.

In the processing flow exemplified in FIG. 9, the control unit F110 of the terminal 100 determines whether the vehicle 10 has entered the general road from the express highway (step S101). As an example, the control unit F110 may determine whether the vehicle 10 has entered the general road from the express highway, based on the history of the traveling route of the vehicle 10 that is acquired by the car navigation system and the current position of the vehicle 10 that is acquired by the position acquisition unit 105. As another example, the control unit F110 may determine whether the vehicle 10 has entered the general road from the express highway, based on the information about the settlement with the ETC in-vehicle machine. In the case where it is determined that the vehicle 10 has not entered the general road from the express highway (the negative determination in step S101), the control unit F110 ends the execution of the processing flow in FIG. 9. On the other hand, in the case where it is determined that the vehicle 10 has entered the general road from the express highway (the positive determination in step S101), the control unit F110 executes the process in step S102.

In step S102, the control unit F110 acquires the traveling-continuable distance of the vehicle 10. As an example, the control unit F110 may acquire the traveling-continuable distance of the vehicle 10, by multiplying the remaining amount of the resupply object in the vehicle 10 by the average fuel economy or average electricity economy of the vehicle 10. After the control unit F110 executes the process of step S102, the control unit F110 executes the process of step S103.

In step S103, the control unit F110 determines whether the traveling-continuable distance acquired in step S102 is less than the first distance length. As an example, the first distance length may be a distance resulting from adding a margin to the distance (the radius of the first area) from the current position of the vehicle 10 to the outside of the first area. As another example, the first distance length may be a distance length resulting from adding a margin to the distance length from the current position of the vehicle 10 to the destination set in the car navigation system. In the case where it is determined that the traveling-continuable distance is equal to or more than the first distance length (the negative determination in step S103), the control unit F110 ends the execution of the processing flow in FIG. 9. On the other hand, in the case where it is determined that the traveling-continuable distance is less than the first distance length (the positive determination in step S103), the control unit F110 executes the process of step S104.

In step S104, the control unit F110 acquires the current position of the vehicle 10 through the position acquisition unit 105. After the control unit F110 executes the process of step S104, the control unit F110 executes the process of step S105.

In step S105, the control unit F110 sends the first information to the server device 200 through the communication module 106. More specifically, the control unit F110 reads the vehicle ID that is stored in the storage unit F120. Subsequently, the control unit F110 generates the first information including the current position of the vehicle 10 that is acquired in step S104 and the vehicle ID that is read from the storage unit F120. Then, the control unit F110 sends the generated first information to the server device 200 through the communication module 106. After the control unit F110 executes the processing of step S105, the control unit F110 executes the process of step S106.

In step S106, it is determined whether the second information that is sent from the server device 200 in response to the first information has been received by the communication module 106. In the case where the communication module 106 has not received the second information (the negative determination in step S106), the control unit F110 waits until the communication module 106 has received the second information. In the case where the communication module 106 has received the second information (the positive determination in step S106), the control unit F110 executes the process of step S107.

In step S107, the control unit F110 determines whether the quotation information is included in the received second information. In the case where the quotation information is not included in the received second information (the negative determination in step S107), the control unit F110 ends the execution of the processing flow in FIG. 9. On the other hand, in the case where the quotation information is included in the received second information (the positive determination in step S107), the control unit F110 executes the process of step S108.

In step S108, the control unit F110 outputs the quotation information included in the second information, through the input-output device 104. More specifically, the control unit F110 generates the first screen based on the position of each of one or more resupply facilities (resupply facilities where the first kind of resupply object is sold) included in the quotation information, the name of each of the one or more resupply facilities, the selling price of the first kind of resupply object at each of the one or more resupply facilities, the first quotation, a first date, and the like. As an example, as described with use of FIG. 8, the first screen includes GUI components that are superimposed on the respective positions of the one or more resupply facilities on the map of the car navigation system and each of which includes an icon, a name, and the selling price of the first kind of resupply object, and a GUI component that includes the character information about the first quotation and the first date. Such a first screen is generated through the car navigation system, and is output through the input-output device 104.

After the control unit F110 executes the process of step S108, the control unit F110 ends the execution of the processing flow in FIG. 9.

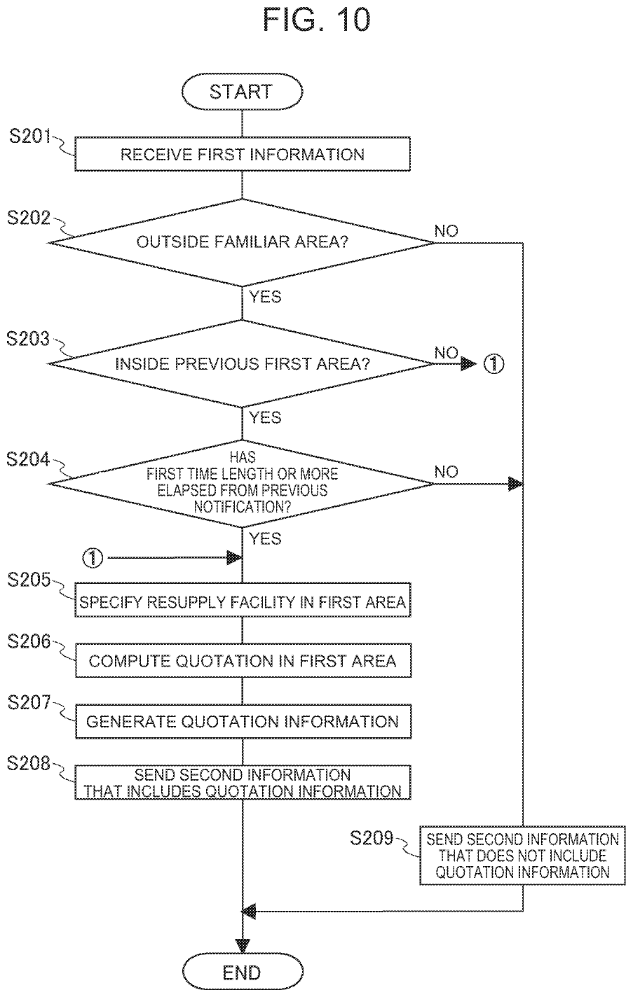

Next, an information process that is performed by the server device 200 in the embodiment will be described based on FIG. 10. FIG. 10 is a flowchart showing a processing flow (a specific processing procedure for the above steps S13 to S16) that is performed by the server device 200. The processing flow shown in FIG. 10 is executed when the communication module 204 receives the first information sent from the terminal 100.

The execution subject of the processing flow in FIG. 10 is the processor 201 of the server device 200, but the description will be made assuming that the software modules of the server device 200 are adopted as the execution subject.

In the processing flow exemplified in FIG. 10, the control unit F210 of the server device 200 receives the first information sent from the terminal 100, through the communication module 204 (step S201). After the control unit F210 executes the process of step S201, the control unit F210 executes the process of step S202.

In step S202, the control unit F210 determines whether the current position of the vehicle 10 is outside the familiar area of the user. More specifically, first, the control unit F210 accesses the vehicle information DB 221 using the vehicle ID included in the first information as an argument, and specifies a vehicle information record in which the information coinciding with the vehicle ID is registered in the field for the vehicle ID. The control unit F210 determines whether the current position of the vehicle 10 is outside the familiar area of the user, based on the information that is registered in the field for the familiar area in the specified vehicle information record and the current position of the vehicle 10 that is included in the first information. In the case where it is determined that the current position of the vehicle 10 is outside the familiar area of the user (the positive determination in step S202), the control unit F210 executes the process of step S203.

In step S203, the control unit F210 determines whether the current position of the vehicle 10 is inside the previous first area. More specifically, first, the control unit F210 determines whether the current position of the vehicle 10 is inside the previous first area, based on the information registered in the field for the area in the previous notification in the above specified vehicle information record and the current position of the vehicle 10. In the case where it is determined that the current position of the vehicle 10 is inside the previous first area (the positive determination in step S203), the control unit F210 executes the process of step S204. In the case where it is determined that the current position of the vehicle 10 is outside the previous first area (the negative determination in step S203), the control unit F210 skips the process of step S204, and executes the process of step S205.

In step S204, the control unit F210 determines whether the first time length or more has elapsed from the previous notification. More specifically, first, the control unit F210 computes the elapsed time length from the date and time in the previous notification in the second information including the quotation information to the current date and time, based on the information registered in the field for the date and time of the previous notification in the above specified vehicle information record and the current date and time. The control unit F210 determines that the computed elapsed time length is equal to or more than the first time length. The first time length may be a period (for example, 24 hours) with which the price of the resupply object that is sold at the resupply facility is updated. In the case where the computed elapsed time length is equal to or more than the first time length (the positive determination in step S204), the control unit F210 executes the process of step S205.

In step S205, the control unit F210 specifies the resupply facility (the resupply facility where the first kind of resupply object is sold in the first area) in the first area. More specifically, first, the control unit F210 sets the first area, based on the current position of the vehicle 10 that is included in the first information. As an example, the control unit F210 sets the first area to a range of a several kilometers radius around the current position of the vehicle 10.

The control unit F210 accesses the facility information DB 222 in the storage unit F220, and extracts all facility information records in each of which the position registered in the field for the position is included in the first area. From the extracted facility information records, the control unit F210 specifies a facility information record in which the information registered in the field for the attribute is adapted to the first kind. For example, in the case where the first kind is high-octane gasoline, regular gasoline, or light oil, the control unit F210 may specify a facility information record in which “gas station” is registered in the field for the attribute, from the above extracted facility information records. Further, in the case where the first kind is hydrogen, the control unit F210 may specify a facility information record in which “hydrogen station” is registered in the field for the attribute, from the above extracted facility information records. Further, in the case where the first kind is electricity, the control unit F210 may specify a facility information record in which “charging station” is registered in the field for the attribute, from the above extracted facility information records.

The control unit F210 specifies resupply facilities that respectively correspond to facility information records specified in the above procedure, as the resupply facility in the first area. After the control unit F210 executes the process of step S205, the control unit F210 executes the process of step S206.

In step S206, the control unit F210 computes the quotation (first quotation) on the selling price of the first kind of resupply object in the first area. More specifically, the control unit F210 accesses the facility information records that respectively correspond to the one or more resupply facilities specified in step S205, and acquires the selling prices registered in the fields for the selling price. The control unit F210 computes the average or median of the one or more acquired selling prices, and decides that the first quotation is the computed average or median. After the control unit F210 executes the process of step S206, the control unit F210 executes the process of step S207.

In step S207, the control unit F210 generates the quotation information. More specifically, first, the control unit F210 acquires the information (the position of the resupply facility, the name of the resupply facility, and the selling price of the first kind of resupply object at the resupply facility) registered in the position fields, name fields and selling price fields in the facility information records that respectively correspond to the one or more resupply facilities specified in step S205. Subsequently, the control unit F210 generates the quotation information including the position of each of the one or more resupply facilities specified in step S205, the name of each of the one or more resupply facilities, the selling price of the first kind of supply object at each of the one or more resupply facilities, the first quotation computed in step S206, and the first date. The first date is the earliest data among the dates registered in the posted date fields in the facility information records that respectively correspond to the one or more resupply facilities specified in step S205. After the control unit F210 executes the process of step S207, the control unit F210 executes the process of step S208.

In step S208, the control unit F210 sends the second information that includes the quotation information generated in step S207, to the terminal 100 through the communication module 204. After the control unit F210 executes the process of step S208, the control unit F210 ends the execution of the processing flow in FIG. 10.

Further, in the case where the negative determination is made in step S202 (in the case where it is determined that the current position of the vehicle 10 is inside the familiar area of the user) or in the case where the negative determination is made in step S204 (in the case where it is determined that the elapsed time length from the previous notification is less than the first time length), the control unit F210 executes the process of step S209. In step S209, the control unit F210 sends the second information that does not include the quotation information, to the terminal 100 through the communication module 204. After the control unit F210 executes the process of step S209, the control unit F210 ends the execution of the processing flow in FIG. 10.

### Operation and Effect of Embodiment

In the above-described embodiment, only in the case where both of the start-up condition and the notification condition are satisfied, the quotation information in the periphery (first area) of the vehicle 10 is output from the terminal 100. As an example, the quotation information in the first area is output from the terminal 100, with the condition that the vehicle 10 has entered the general road from the express highway, the current position of the vehicle 10 is outside the familiar area of the user of the vehicle, the first time length or more has elapsed from the previous notification, or the current position of the vehicle 10 is outside the previous first area, and the traveling-continuable distance of the vehicle 10 is less than the first distance length.

Consequently, it is possible to avoid the quotation information from being output when the vehicle 10 is traveling on the express highway, to avoid the quotation information from being output when the vehicle 10 is traveling in the familiar area of the user (when the user knows the quotation on the resupply object in the periphery of the vehicle 10), to avoid the quotation information (the same quotation information as the previous quotation information) from being output when the first time length or more has not elapsed from the previous notification and the current position of the vehicle 10 is inside the previous first area, and to avoid the quotation information from being output when the traveling-continuable distance is equal to or more than the first distance length (when the resupply of the resupply object is not necessary).

Accordingly, with the embodiment, it is possible to present the information (quotation information) relevant to facilities in the periphery of the vehicle 10, to the user, while restraining the user from having a feeling of botheration. As a result, it is possible to improve the convenience for the user when the information relevant to supply facilities in the periphery of the vehicle 10 is presented.

Further, in addition to the first quotation, the quotation information in the embodiment includes the position of each of one or more resupply facilities in the first area and the selling price of the resupply object at each of the one or more resupply facilities. Thereby, the user can know the position of each of the one or more resupply facilities in the first area and the selling price of the resupply object at each of the one or more resupply facilities, and can determine whether the selling price of the resupply object at each of the resupply facilities is high or low compared to the first quotation.

Further, the quotation information in the embodiment includes only the information (the first quotation corresponding to the first kind of resupply object, the position of the resupply facility where the first kind of resupply object is sold, and the selling price of the first kind of resupply object at each resupply facility) relevant to the kind of resupply object (the first kind of resupply object) that is adapted to the vehicle 10. Thereby, it is possible to further restrain the user from having a feeling of botheration.

Further, the quotation information in the embodiment includes the date (first date) when the selling price used for the computation of the first quotation was posted. Thereby, the user can know the time point when the information about the presented selling price and first quotation was released.

### ADDITIONS

The above embodiment is just an example, and the present disclosure can be carried out while being appropriately altered without departing from the spirit of the present disclosure. Further, a process described as a process that is performed by a single device may be executed so as to be shared by a plurality of devices. Alternatively, processes described as processes that are performed by different devices may be executed by a single device. In the computer system, the hardware configuration that realizes the functions can be flexibly altered.

For example, the server device 200 may execute both the determination of whether the start-up condition is satisfied and the determination of whether the notification condition is satisfied. In that case, the server device 200 may acquire the information (for example, the history of the traveling route of the vehicle 10, the traveling-continuable distance, and the like) necessary for the determination of the start-up condition, from the terminal 100, and may determine whether the start-up condition is satisfied, based on the acquired information. Furthermore, the server device 200 may generate a user interface screen as described with FIG. 8, and may send the generated user interface screen to the terminal 100. In this configuration, the server device 200 corresponds to the “information processing device” according to the present disclosure. Further, the combination of the start-up condition and the notification condition corresponds to the “first condition” according to the present disclosure.

Further, the terminal 100 may execute both the determination of whether the start-up condition is satisfied and the determination of whether the notification condition is satisfied. In that case, a storage region that stores the same information as the vehicle information record shown and described in FIG. 5 may be constructed in the storage unit F120 of the terminal 100. Furthermore, the terminal 100 may execute an information process for generating the quotation information. In that case, a storage region that stores the same information as the facility information DB 222 may be constructed in the storage unit F120 of the terminal 100. Alternatively, a database that stores the same information as the facility information DB 222 may be constructed in an external device that is connected with the terminal 100 through the network N1, and the terminal 100 may acquire the information necessary for the generation of the quotation information, by accessing the database through the network N1. In this configuration, the terminal 100 corresponds to the “information processing device” according to the present disclosure.

Further, the present disclosure can be realized also when a computer program (information processing program) in which the functions described in the above embodiment are implemented is supplied to a computer and the program are read and executed by one or more processors included in the computer. The computer program may be provided to the computer through a non-transitory computer-readable storage medium that can be connected to a system bus of the computer, or may be provided to the computer through a network. The non-transitory computer-readable storage medium is a recording medium that can holds information such as data and programs by electric, magnetic, optical, mechanical, or chemical action and that can be read by the computer and the like. Examples of the recording medium include an arbitrary type of disk or disc such as a magnetic disk (a floppy (R) disk, an HDD, or the like), and an optical disc (a CD-ROM, a DVD disc, a Blu-ray disc, or the like). Further, the recording medium may be a medium such as a ROM, a RAM, an EPROM, an EEPROM, a magnetic card, a flash memory, an optical card, or a solid state drive (SSD).

What is claimed is:

1. An information processing device comprising one or a plurality of processors configured to execute:
acquiring a first quotation in response to satisfaction of a first condition, the first quotation being a quotation on a selling price of a resupply object at one or more resupply facilities in a first area that includes a current position of a vehicle; and
outputting quotation information that includes the first quotation.

2. The information processing device according to claim 1, wherein the first condition includes a condition that the vehicle has entered a general road from an express highway.

3. The information processing device according to claim 1, wherein the first condition includes a condition that the current position of the vehicle is outside a familiar area of a user of the vehicle.

4. The information processing device according to claim 1, wherein the first condition includes a condition that a first time length or more has elapsed from a previous output of the quotation information or the current position of the vehicle is outside a previous first area.

5. The information processing device according to claim 1, wherein the first condition includes a condition that a traveling-continuable distance of the vehicle is less than a first distance length.

6. The information processing device according to claim 1, wherein the acquiring the first quotation includes:
acquiring the selling price of the resupply object at each of the one or more resupply facilities in the first area; and
computing the first quotation based on the selling price of the resupply object at each of the one or more resupply facilities.

7. The information processing device according to claim 6, wherein the resupply object is a kind of resupply object that is adapted to the vehicle.

8. The information processing device according to claim 7, wherein the outputting the quotation information includes:
outputting the first quotation; and
outputting a position of each of the one or more resupply facilities in the first area and the selling price of the resupply object at each of the one or more resupply facilities.

9. The information processing device according to claim 8, wherein the outputting the quotation information further includes outputting a date when the selling price of the resupply object at each of the one or more resupply facilities in the first area is posted.

10. An information processing method that is executed by a computer, the information processing method comprising:
acquiring a first quotation in response to satisfaction of a first condition, the first quotation being a quotation on a selling price of a resupply object at one or more resupply facilities in a first area that includes a current position of a vehicle; and
outputting quotation information that includes the first quotation.

11. The information processing method according to claim 10, wherein the first condition includes a condition that the vehicle has entered a general road from an express highway.

12. The information processing method according to claim 10, wherein the first condition includes a condition that the current position of the vehicle is outside a familiar area of a user of the vehicle.

13. The information processing method according to claim 10, wherein the first condition includes a condition that a first time length or more has elapsed from a previous output of the quotation information or the current position of the vehicle is outside a previous first area.

14. The information processing method according to claim 10, wherein the first condition includes a condition that a traveling-continuable distance of the vehicle is less than a first distance length.

15. The information processing method according to claim 10, wherein the acquiring the first quotation includes:
acquiring the selling price of the resupply object at each of the one or more resupply facilities in the first area; and
computing the first quotation based on the selling price of the resupply object at each of the one or more resupply facilities.

16. The information processing method according to claim 15, wherein the resupply object is a kind of resupply object that is adapted to the vehicle.

17. The information processing method according to claim 16, wherein the outputting the quotation information includes:
outputting the first quotation; and
outputting a position of each of the one or more resupply facilities in the first area and the selling price of the resupply object at each of the one or more resupply facilities.

18. The information processing method according to claim 17, wherein the outputting the quotation information further includes outputting a date when the selling price of the resupply object at each of the one or more resupply facilities in the first area is posted.

19. An information processing system comprising:
a terminal associated with a vehicle; and
a server device configured to communicate with the terminal, wherein:
the terminal is configured to send a current position of the vehicle to the server device, in response to satisfaction of a second condition;
the server device is configured to
acquire a first quotation in response to satisfaction of a third condition, and
send quotation information that includes the acquired first quotation, to the terminal, the first quotation being a quotation on a selling price of a resupply object at one or more resupply facilities in a first area that includes the current position of the vehicle; and
the terminal is configured to output the quotation information.

20. The information processing system according to claim 19, wherein:
the second condition includes at least one of a condition that the vehicle has entered a general road from an express highway and a condition that a traveling-continuable distance of the vehicle is less than a first distance length; and
the third condition includes at least one of a condition that the current position of the vehicle is outside a familiar area of a user of the vehicle and a condition that a first time length or more has elapsed from a previous output of the quotation information or the current position of the vehicle is outside a previous first area.
